(19) United States
(12) Patent Application Publication
(10) Pub. No.: US 2021/0354405 A1
(43) Pub. Date: Nov. 18, 2021

(54) METHOD OF MANUFACTURING OF A COMPOSTABLE PACKAGING ARTICLE COMPRISING AT LEAST TWO COMPOSTABLE MATERIALS

(71) Applicant: G-PAK Technology Inc., Surrey (CA)

(72) Inventors: Darren Joseph Footz, Surrey (CA); Zachary Michael Hudson, Vancouver (CA)

(21) Appl. No.: 17/323,431

(22) Filed: May 18, 2021

Related U.S. Application Data
(60) Provisional application No. 63/026,576, filed on May 18, 2020.

(51) Int. Cl. B29C 70/68; B65D 85/804; B65D 65/46

(52) U.S. Cl. CPC B29C 70/682; B29K 2001/00; B65D 65/466; B65D 85/8061

(57) ABSTRACT

The present disclosure is directed to methods and apparatus for making beverage containers that deteriorate after they are disposed of. Beverage containers or cartridges of the present disclosure may be similar to conventional non-biodegradable single-use coffee beverage pods or cartridges. Beverage containers of the present disclosure may be made from two or more different types of materials that readily decompose in the environment based on the different types of materials having different characteristics. For example, a first material may have a low porosity and be more hydrophobic than a second material that decomposes faster than the first material. Decomposition of the second material may cause the first material to decompose faster than it normally would as this accelerated decomposition may be based on the first material being in close proximity to microbes decomposing the second material.

### CROSS-REFERENCE TO RELATED APPLICATIONS

This Application claims priority benefit of U.S. provisional patent application 63/026,576 filed on May 18, 2020, the disclosure of which is incorporated herein by reference.

### BACKGROUND OF THE INVENTION

### Field of the Invention

The present disclosure relates to the improved beverage cartridges. More specifically the present disclosure is directed to beverage cartridges made of various types of biodegradable materials and to method for making such cartridges.

### Description of the Related Art

Single-serve beverage cartridges have become a dominant method for serving beverages, especially hot beverages, in a variety of settings such as homes, offices, waiting rooms, hotel rooms and lobbies, and other places where people consume beverages. The rapid growth of single-serve beverage cartridges is driven by consumer preference for convenient, quickly prepared beverages in single-portion quantities. Drinks prepared using these beverage cartridges are available in a variety of flavors and beverage types. Different types of beverages made using these cartridges include coffee, decaffeinated coffee, espresso, tea, decaffeinated tea, cider, hot cocoa/chocolate, bone broth, and certain alcoholic beverages. Examples of some alcoholic beverages include Irish Coffee, Hot Toddy, and Hot Buttered Rum. Even within a beverage type, such as coffee, there may be a plurality of roasts and associated roasters, flavor profiles, flavor additives, caffeine strengths, location or locations of origin, etc.

The convenience and variety of single serving beverage cartridges allows and encourages consumers to prepare and consume a plurality of beverages throughout the day. This pattern of consumption results in the rapid accumulation of used beverage cartridges wherever they are consumed. Due to the nature of single-serving beverage cartridges, a considerable amount of packaging waste is produced per beverage consumed compared to preparing beverages by traditional means, such as, preparing a plurality of servings at once using bulk ingredients. Packaging waste, according to the United States Environmental Protection Agency (EPA), defines containers and packaging as products that are assumed to be discarded the same year the products they contain are purchased. The EPA further estimates that the majority of the solid waste are packaging products contributes significantly to global pollution, the introduction of contaminants into the natural environment that that pose a health risk many forms of life, including humans, animals, plants, fungi, etc.

Single-serve beverage cartridges typically comprise several components made of various materials. The typical components of a single-serve beverage cartridge include, at least, a container, typically made from plastic such as polyethylene, a filter, typically made from plant fiber such as abaca fibers or other natural and synthetic fibers, and a container lid, typically made from food-grade aluminum foil, which is also commonly printed upon to include product labelling. Some beverage cartridges do not contain a filter, typically when the beverage material is readily soluble in hot water (i.e. hot cocoa). Conventional containers usually comprise an opening on the top of the container, and a hollow cavity within which and across which a filter may be disposed. These containers may also comprise an opening at on the bottom of each container.

When manufactured a filter and beverage material may be inserted into a cup shaped container. Next, after the filter and beverage material are inserted into the container, a lid is then typically sealed over an opening of the container. The sealed lid typically provides an airtight seal, preventing the exchange of gases between the environment and the interior of the container, thus preventing/impeding oxidation and/or spoilage of the beverage material. In beverage cartridges that include a filter, the filter may separate the container into two chambers: a first chamber occupying the space within the container between the filter and the opening of the container, this first chamber may be used for holding a single serving of a dry beverage ingredients. A second chamber in such a dual chamber beverage container may occupy a space within the container between the filter and a base of the container. This second chamber is typically located on at an opposite side of the filter relative to a location of the first chamber.

Currently, the container of a beverage cartridge for single-serve use is typically made from forms of petroleum-based plastic materials that are considered to be non-biodegradable nor compostable. In some cases, the containers may be made of petroleum based materials, such as polybutylene adipate terephthalate (PBAT) that are somewhat degradable, yet degrade in a manner that still pollutes the environment with petroleum residue, microplastics, or other chemicals that may not be desirable for compost or for dispersion in the environment.

Composting is the mixing of various decaying organic substances, such as dead plant matter, which are allowed to decompose to the point that various waste products of the composting process provide nutrients to be used as soil conditioners/fertilizers. Composting can be aerobic, anerobic, and/or vermicomposting, depending on the environment in which the compost is prepared. Aerobic composting is the decomposition of organic matter by microbes that require oxygen to process the organic matter. The oxygen from the air diffuses into the moisture that permeates the organic matter, allowing it to be taken up by the microbes. Anerobic composting is the decomposition of organic matter by microbes that do not require oxygen to process the organic matter. To be anerobic, the system must be sealed from the air, such as within a plastic barrier. Anerobic compositing produces an acidic environment to digest the organic material. Vermicomposting is the decomposition of organic matter by worms and other animals (such as soldier flies). A portion of the organic matter is converted to vermicast, or castings from the worms or other animals. The breakdown of the organic matter into vermicast yields an effective soil conditioner and/or fertilizer.

The cover of a conventional beverage pod is typically made of a metal foil (e.g., aluminum) or a metal foil laminate which is glued to the top of the container. Generally, neither the metal foil of the cover nor the glue affixing the cover over the opening of the container are biodegradable, compostable or made from readily renewable resources. As a result, non-biodegradable and non-compostable beverage cartridges typically end up in landfills where they contaminate the environment. This may be especially problematic due to the fact that traditional means of brewing beverages, e.g., using solely beverage material and filter material, or a filtration device (such as a French press, or a wire mesh filter) that may yield a completely compostable waste product (e.g., spent coffee grounds and potentially a used paper filter).

Attempts have been made to recycle plastic beverage pods/containers in some cases. Recycling has many issues which effect the efficacy and practicality of these programs. The first is collection and transportation. Collection largely requires voluntary compliance by consumers. Some deposit programs encourage consumers to return recyclable materials, however this accounts for very few recyclable materials actually being recycled. Collection is further complicated by the need to further transport the materials to a facility which can process them. Many of these facilities are run by municipalities as recycling operations frequently lack economic viability without government subsidies. Recycling of plastics and other materials is further complicated by cross contamination and downcycling. Cross contamination is the presence of foreign materials not desired in an end product made from recycled materials. Removal of contaminates also requires sorting and cleaning of materials. This process can be partially automated, however, it also requires manual sorting and inspection which adds cost, reduces the amount of material that can be processed in a time period, and inevitably results in a less pure product than when using virgin material.

Downcycling is the term used to describe the reduction of quality in recycled materials compared to materials that otherwise could potentially be recycled. Impurities introduced during processing, from non-recyclable waste that could not be removed, or from other plastics and materials can make the resulting material unsuitable for use in their original applications. As such, the applications for recycled materials, especially plastics, are limited, as is the number of times that plastics can be recycled.

Beverage containers, such as instant beverage cups or pods, are particularly difficult to recycle. Not only do they have non-recyclable materials contained within them that would first need to be removed, they are frequently comprised of at least two different materials. For example, may beverage containers include a non-biodegradable plastic cup and a non-biodegradable aluminum foil lid. In instances when the lid is made of plastic, it is often a different type than the cup, and recycling these two different types of plastics require that these plastic be separated prior to being recycled. This increases the complexity of the recycling operation, requiring at least three separate streams for each type of refuse, each requiring their own preparation. Furthermore, the small size of these beverage pods creates a disproportionate amount of effort required to recycle a small amount of material.

The separation of materials would ideally be performed by the consumer prior to recycling; however, this inconvenience inevitably results in consumers recycling the beverage containers without proper preparations, or failing to recycle the container at all. Consumers often just decide to discard the container as trash.

One of the major advantages of using beverage pods is consumer convenience, such that a beverage can be prepare by simply inserting a cartridge into a machine that performs all other brewing functions. It is therefore undesirable to instruct consumers to disassemble and sort various materials from the beverage pod, due to the diminutive size of beverage pods, this may not be physically possible for consumers without fine motor skills necessary to disassemble such an item.

Plastics are traditionally made from petroleum and are processed with chemicals to create polymers which can then be formed into shapes. Many of the chemicals used to produce these polymers used in making plastics are inherently toxic and can leech into the contents of products they contain. This is why few types of plastics are approved for use with foods. Some materials may be safe storing some types of food products, such as dry goods, however when a solvent is introduced, the chemicals in the plastic can go into solution. In the past, some plastics that were previously approved for use with foods have been found to leech chemicals. For example, BPA (Bisphenol A) is a chemical that was previously approved for food contact and then was later removed from the list of approved food grade plastics. Other chemicals that can be found in plastics include thalates, antiminitroxide, brominated flame retardants and poly-fluorinated chemicals. Depending on the chemical and the manner in which the plastic is used, it can cause irritation in the eye, vision failure, breathing difficulties, respiratory problems, liver dysfunction, cancers, skin diseases, lung problems, headache, dizziness, birth defects, as well as reproductive, cardiovascular, genotoxic, and gastrointestinal issues.

There has been a push from some governments to mandate composting and increase the amount of recycled material to reduce the amount of waste being incinerated or buried in landfills. Some laws such in the European Union, set specific targets, such as 65% of waste recycled by 2035. In the United States, there is no national law, but roughly half of states have some form of recycling law and municipalities may further add to these laws resulting in a varying patchwork of regulations and mandates. Some laws are very limited, requiring that some bottles and cans be recycled. Many of these states also add deposits to bottles, adding monetary value and incentive to returning them for recycling. Others require only specific recyclable materials be recycled, while others may be permitted to be discarded in the trash. Some states go further, mandating that compostable waste be disposed of properly, either in a home composter, or via an industrialized composting operation.

A further complication to composting plastics is that not all plastics break down the same. Some plastics, whether petroleum based or bioplastics are biodegradable. Only a small subset of these are also compostable. The distinction lies in how quickly the plastic breaks down, and whether the process of degradation releases harmful chemicals into the environment. Compostable plastics typically degrade within 12 weeks, where biodegradable plastics will typically break down within 6 months. Ideally, compostable plastics would break down at the same rate as common food scraps, about 90 days.

Another class of plastics are OXO-degradable plastics. These are different than biodegradable plastics in that they are traditional plastics with additional chemicals which accelerate the oxidation and fragmentation of the materials under ultraviolet (UV) light and/or heat. This allows the plastics to break down more quickly, however the result is pollution from microplastics, as the plastic molecules themselves do not degrade any faster than their traditional plastic counterparts. There have been efforts in some jurisdictions to ban OXO-degradable plastics.

A pervasive problem with compostable packaging materials is the reduced speed in which compostable packaging materials decompose in compost. Speed of decomposition may be a concern with compostable packaging, as it determines when the compost pile can be used for secondary functions, e.g., providing organic matter or fertilizer for soil and plants. Speed of decomposition may be especially a concern for compostable packaging, compared to food and yard scraps. This is because the appearance of manufactured materials in a compost pile is undesirable to home composters and industrial composters alike, as it may give the impression that compost is contaminated with petroleum-based plastics. There are several causes to this problem, the first of which is that microbiology, which is the force primarily responsible for decomposition. Certain microbes are not well adapted to break down certain compostable packaging materials quickly. Bacteria, fungi, and other decomposing forms of life evolved over millions of years to efficiently consume plant matter as a primary food source.

For all of the reasons discussed above, what are needed are new forms of packaging that may be used as beverage containers that deteriorate more rapidly than conventional types of packaging without contaminating the environment.

### SUMMARY OF THE PRESENTLY CLAIMED INVENTION

The presently claimed invention relates to a method for making biodegradable beverage container (i.e. cartridge) and a beverage container that is biodegradable. In a first embodiment a method for making the beverage container includes receiving a first and a second material for making the container, the first material associated with a first decomposition rate and the second material associated with a second decomposition rate that is different from the first decomposition rate. This method may also include fabricating a first portion of the container, fabricating a second portion of the container, inserting a filter into the second portion of the container, and completing assembly of the container. The first portion or the second portion of the container may be made of at least one of the first material or the second material and the filter may include a material for making a beverage. The assembly of the container may also include bonding the first portion of the container to the second portion of the container. After a beverage has been made from the beverage making material, the container may biodegrade based on the container including both the first and the second material.

In a second embodiment, a container for making a beverage may include a first portion, a second portion, and a filter included in the second portion of the container. Here again the first portion and the second portion of the container may be made of at least one of the first material or the second material and the filter may include a material for making a beverage. This container may biodegrade after the beverage has been made from the beverage making material as a result of the container including both the first and the second material.

### BRIEF DESCRIPTIONS OF THE DRAWINGS

FIG. 1 depicts a block diagram of a compostable beverage pod or container of the present disclosure.

FIG. 2 illustrates a method that may be used to manufacturing a compostable packaging article with accelerated decomposition

FIG. 3 displays a graphical representation of a blend or composite of materials used to make portion of a beverage container.

FIG. 4 illustrates a method for combining two different materials with different decomposition rates into a blend or composite material.

### DETAILED DESCRIPTION

The present disclosure is directed to methods and apparatus for making beverage containers that deteriorate after they are disposed of. Beverage containers or cartridges of the present disclosure may be similar to conventional non-biodegradable single-use coffee beverage pods or cartridges. Beverage containers of the present disclosure may be made from two or more different types of materials that readily decompose in the environment based on the different types of materials having different characteristics. For example, a first material may have a low porosity and be more hydrophobic than a second material that decomposes faster than the first material. Decomposition of the second material may cause the first material to decompose faster than it normally would as this accelerated decomposition may be based on the first material being in close proximity to microbes decomposing the second material. By using different types of biodegradable materials, beverage containers of the present disclosure more environmentally friendly than conventional beverage containers. Materials used to make beverage containers of the present disclosure may include bio-plastics, cellulose, or selected biodegradable petroleum based materials.

Various types of naturally derived packaging materials, including materials that are forms of organic plastics or cellulose are available today for use in building environmental friendly packaging. Some types of these environmental friendly packaging materials are more hydrophobic, less porous, or both more hydrophobic and less porous than other types environmental friendly packaging materials. These other types environmental friendly packaging materials decompose more rapidly than the more hydrophobic and/or less porous materials. Polylactic acid (PLA) is considered to be a bioplastic formed by condensation of lactic acid and PLA is a biodegradable material. PLA is also more hydrophobic and less porous than cellulose. Cellulose is a plant deriver material that can also be used to make packaging and cellulose degrades more rapidly than PLA. Cellulose is considered to be a compostable material.

As mentioned above the present disclosure is directed to using different materials with different characteristics to make beverage containers for use in commercially available beverage making/dispensing machines, such as a coffee maker. By combining at least two different materials to create packaging, advantages of each of the materials relied upon to make containers that have a robustness suitable for beverage dispensing applications and that are more suitable for degrading after these beverage containers are discarded.

Observations have shown that combinations of PLA and other materials degrade more rapidly the environment than PLA that is not exposed to these other materials. These observations show that combinations of naturally decomposable materials with different characteristics have superior characteristics than characteristics associated with a single type of naturally decomposable material.

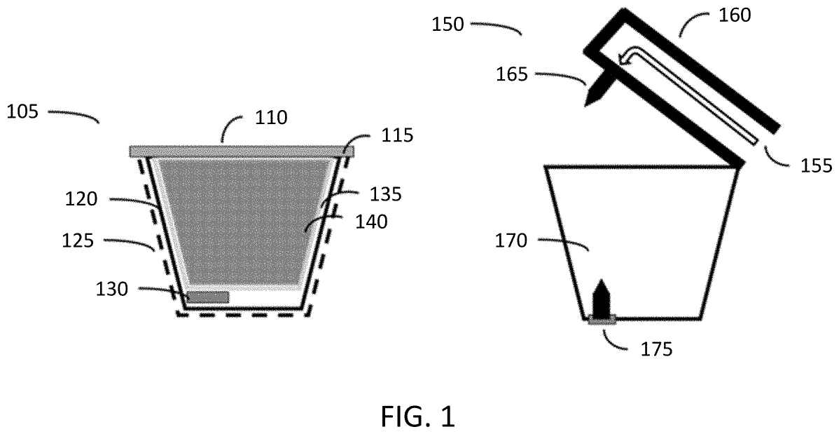

FIG. 1 depicts a block diagram of a compostable beverage pod or container of the present disclosure. The beverage container 105 of FIG. 1 includes lid 110, bonding location 115, casing 120, optional outer coating 125, filter guard 130, filter 135, and beverage materials 140 located inside of filter 135. FIG. 1 also illustrates beverage extraction/brewing machine assembly 150 used to extract elements included in a beverage container when a fluid is introduced into a brewing/extraction chamber 170. This fluid may be provided to the extraction/brewing assembly from fluid source 155 and through the beverage materials included in the beverage container. The beverage machine assembly 150 of FIG. 1 includes fluid source 155, extraction/brewing assembly chamber lid 160, brewing/extraction chamber 170, piercing element/nozzle 165 that receives fluid from fluid source 155, and outlet 175 that may also include an element that pierces a bottom portion of a beverage container.

In operation chamber lid 160 the beverage machine 150 would be opened, beverage cartridge 105 would be placed into chamber 170, chamber lid 160 would then be closed, and a button may be pressed to initiate the flow of a fluid (e.g. water) from fluid source 155 through piercing element/nozzle 165. The closing of lid 160 could force piecing elements of nozzle 165 and outlet 175 to pierce respectively a top part and a bottom part of beverage cartridge 105. Filter guard 130 of beverage cartridge 105 may help prevent the piercing element of outlet 175 from reaching or piercing filter 135. Here the liquid flowing from fluid source 155 would flow through piercing nozzle 165 into the top of beverage cartridge 105, through filter 135 and beverage materials 140, and out of outlet 175 when a beverage is made.

Beverage pod/cartridge 105 of FIG. 1 may include one or more of, a beverage medium that is either soluble or insoluble, one or more filters, and a first portion in which liquid is passed into and a second portion through which liquid passes out of the cartridge. In some instances, portioned beverage packages contain a water-soluble material, to make a drink such a hot chocolate, chai tea, etc. These portioned packages can be pouches as well as pods for beverage brewing machines. Beverage cartridges can contain a number of components, including pod lid, capsule lid, or cartridge lid. The lid of a beverage pod is often made of foil that may be glued to a bottom portion of a cartridge to seal a beverage material inside of the cartridge.

Cartridge lid 110 of FIG. 1 may be comprised of a compostable natural material, for example, a spun bond PLA web film material (e.g., a material including polylactic acid (PLA), any polymer selected from the class of polymers known as polyhydroxyalkanoates (PHAs) (such as polyhydroxybutyrate (PHB), or a combination thereof), a cellulose paper film, or other type of compostable nonpolluting material. Lid 110 may be bonded to an upper portion/bonding location 115 of casing 120. In certain instances, filter 135 may be bonded to an internal surface of casing 125. These bonds may be a mechanical or chemical bond. Here a mechanical bond may be created using heat sealing or ultrasonic welding and a chemical bond may be created using a food grade adhesive. The bonding of a lid or a filter onto or into a case may include creating bods at in one location or may include several separate bonds at different locations of a case. A filter bond may be a type of capsule bond that binds the filter medium to a portion of the capsule. Here again this may include ultrasonic welding, adhesives, or thermal sealing. A capsule may include an exterior surface that is includes a series of holes, that includes portions of a filter element, or may be a filter material similar to a tea bag that contains a material for making a beverage.

The process of manufacturing beverage cartridge 105 may include coating exterior portions of cartridge 105 with a coating 125 material. Coating 125 may have been applied as part of process where the coating is sprayed onto outer surfaces of cartridge 105. Alternatively, cartridge 105 may be placed into a mold and the coating 125 may be extruded into the mold when external surfaces of cartridge 105 are coated.

The exterior of cartridge 105 can be made of a non-polluting plastic (such as PLA, PHAs, PHB, or combinations thereof), cellulose, etc. Combinations of various materials (that may include PLA, PHA, PHB, or cellulose) have some properties that are similar to properties of petroleum based thermoplastic polymers (e.g. polypropylene (PP), polyethylene (PE), and polystyrene (PS)) and have other properties that are different from most petroleum based thermoplastic polymers. What this means is that items made from PLA, PHAs, PHB, and/or cellulose can have the look and feel of “plastic,” yet biodegrade over a span of weeks or months, where items made from PP, PE, and PS, or other petroleum based thermoplastic polymers may not fully degrade over weeks, months, or even many years. This allows for beverage container made from PE, PHA, cellulose, and or other similar organic materials to serve as a biodegradable alternative to coffee pods made using petroleum based thermoplastic polymers.

PLA and PHA materials are renewable materials that may be produced using bacterial fermentation of sugar or lipids that may have been derived from corn, cassava, sugarcane, or sugar beet pulp. Mechanical properties of PHAs can be modified for a given use case by blending PHA material with other biodegradable polymers, such as PLAs. Other types of biodegradable materials from which plastic may be made include poly-L-lactide (PLLA). PLLAs are also considered to be compostable materials because of how quickly PLAA materials can degrade in the environment. Cellulose materials are made from fibers derived from plant matter. Cellulose may be collected by processing cotton, flax, wood pulp, hemp, and other plant materials. These various materials may be used to fabricate a biodegradable filter material that could be used in coffee or other beverage pods/cartridge. What this means is that non-petroleum based organic materials may be used to form various parts of a beverage cartridge.

Other materials that are biodegradable plastic alternatives include petroleum-based plastics such as, polyglycolic acid (PGA), polybutylene succinate (PBS), polycaprolactone (PCL), polyvinyl alcohol (PVOH) and polybutylene adipate terephthalate (PBAT). In certain instances these other materials may be used to fabricate a portion of a beverage cartridge, for example, casing 120 of FIG. 1.

Filters included in a cartridge may be made of any of the materials or combination of materials discussed in the present disclosure in order to help insure that the entire cartridge biodegrades within weeks of months after being used. Beverage cartridges can also contain a capsule interior that is separate from a filter, in beverages that have an insoluble beverage material such as coffee. The capsule interior can be used for a number of purposes, including, providing material properties such as structural integrity (e.g., provide addition strength to resist the pressure of liquid injection in the process of brewing a beverage, which may crack or otherwise compromise the beverage pod), or altering the biodegradability or rate of the beverage pod in some embodiments. For example, coating 125 may be a material that alters the biodegradability of materials included in casing 120 or vice versa.

As mentioned above, filter guard 130 is a structure integrated into a beverage pod that prevents a sharp part of outlet 175 from piercing filter 135. In some embodiments, an interior of cartridge 120 may include integrated features to act as a filter guard, removing the requirement for a discrete filter guard 130. Filter 135 may be made from as spun bond PLA webbing material, cellulose paper, cloth, or metal. A main purpose of filter 135 and filter guard 130 is to prevent an insoluble portion of a beverage material from leaving the beverage pod and entering the beverage brewing/extraction machine or a beverage made by a brewing machine. These filters can be symmetrical (e.g., fluted), or asymmetrical (e.g. pleated).

Here a beverage material is the material used to produce a brewed or extracted beverage, such as coffee grounds, tea, or a mix beverage where the beverage material is soluble, such as hot chocolate. Beverage materials may include flavorings, nutritional content (e.g., any oils, nutritional supplements, active ingredients such as pharmaceuticals, cannabinoids, etc.), alcohol, coloring, or any other composition which has an effect on the final beverage. Beverage brewing/extraction machines for making portioned beverages from pre-packed beverage pods exist for a variety of beverages. These beverage materials may include portions that are made insoluble (e.g., coffee) or may include materials that are completely soluble (e.g., hot chocolate mix).

A beverage brewing/extraction machine will typically contain many other components, such as, for example, a heating element, a liquid reservoir or plumbing component, a liquid pump, an exterior chassis, a controller for the brewing process, a display or indicator lights and sounds, a user interface including buttons or a touchscreen, a tray to catch spillage, etc. For the purposes of description, it is assumed a beverage brewing/extraction machine contains all components necessary to accomplish the beverage brewing process, though specific reference to beverage brewing machine components may only be made to those components which come into direct contact with the beverage pod, such as the brewing chamber, a fluid injecting component, and a fluid extracting component. A beverage brewing/extraction machine may include the following elements: A fluid source that supplies 155 a fluid or liquid (usually water) to the brewing machine for producing the desired beverage. A brewing chamber lid 160 that opens to allow a new pod to be added to the machine, and in many of the most common embodiments of a beverage brewing machine, the chamber lid 120 connects the fluid source 155 to the brewing piercing element/nozzle 165. As mentioned above nozzle 165 provides the fluid when a beverage is created. Here again chamber 170 may receive beverage container 105 and a piercing nozzle of output 175 may pierce the bottom of container 105 to allow the created beverage to flow through output 175.

Different portions of a beverage cartridge may be made of one or more types of biodegradable or compostable materials or combinations of materials that degrade after a cartridge has been used to make a beverage. In one instance, an exterior of a beverage cartridge may be made of one type of material or combinations of materials where a filter or capsule that contains a beverage making material may be made of type of material that is different from materials used to make the exterior of the beverage container. For example, an exterior of a beverage container may be made of cellulose and the filter or capsule contained within the beverage container may be made of a selected type of PLA.

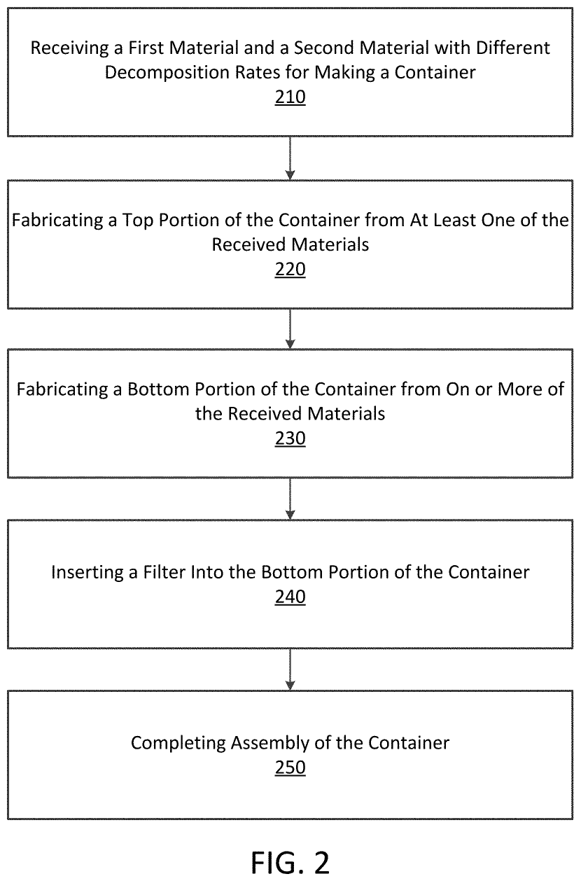

FIG. 2 illustrates a method that may be used to manufacturing a compostable packaging article with accelerated decomposition. FIG. 2 begins with step 210 where a first material with a first decomposition rate and a second material with a second decomposition rate are received. The decompensation rates associated with the first material and the second material may be different. For example, the decomposition rate of the first material may be slower than the decomposition rate of the second material. Each of these materials may be considered as being biodegradable or compostable. The material may be considered biodegradable based on the first decomposition rate and the second material may be considered compostable based on the second decomposition rate.

The materials received in step 210 may be materials made from processing or fermenting plant material—essentially materials that are not made from petroleum. Because of this, the materials received in step 210 may include, yet are not limited to polylactic acid (PLA), any polymer from the class of polymers known as polyhydroxyalkanoates (PHAs), such as polyhydroxybutyrate (PHB), poly-L-lactide (PLLA), or cellulose.

Alternatively, petroleum based materials that are considered biodegradable may be received in step 210 of FIG. 2. Select petroleum based materials received in step 210 may include, yet may not be limited to polyglycolic acid (PGA), polybutylene succinate (PBS), polycaprolactone (PCL), polyvinyl alcohol (PVOH) and polybutylene adipate terephthalate (PBAT). In certain instances, the materials received in step 210 may include two or more of PLA, PHA, PHB, PLAA, PGA, PBS, PCL, PVOH, and PBAT. The materials received in step 210 may be received because they are known to be decomposed by one or more microorganisms that can feed on the selected materials.

Here the first biodegradable/compostable material may have a surface of low porosity and high hydrophobicity and the second biodegradable/compostable material may have a higher rate of decomposition compared to the first material. Here the first compostable material, may include polylactic acid (PLA) or lactic acid copolymers.

Next in step 220 a top portion or lid of a container may be fabricated from the received materials, for example from PLA, and in step 230 a bottom portion of the container may be fabricated from the received materials, for example from cellulose. After step 230, a filter may be inserted into the bottom portion of the container in step 240 and assembly of the container may be completed in step 250. Here the filter may be used to contain a material for making a beverage within the container. For example, the filter may contain coffee, tea, chocolate powder, or other materials commonly used to make beverages. After the container has been used to make a beverage and after it has been disposed of, the combination of materials used to make the container may increase the rate of decomposition of at least one of the materials based on the container including the two different materials received in step 210 of FIG. 2.

As mentioned above the process of assembling the container may include bonding the filter inside of the container and bonding a lid on the container. This process may also include bonding the top portion of the container onto the bottom portion of the container. After the container is disposed of, for example, when these polymers are placed in soil or sea water, these polymers will start to decompose. In a compost, these materials biodegrade. Due to the typical manufacturing methods associated with thermoplastics, PLA tends to have low porosity, which may be desirable in some applications, such as, for creating an airtight seal for a beverage pod. Since materials that have low porosity tend to be slower to break down than similar materials with higher porosity and since increased porosity contributes to greater surface area at the microscopic scale, by combining one material that has lower porosity with another material that has higher porosity relative to the first material, decomposition of the material with lower porosity may be accelerated based on the first and the second materials being included in a single container. Decomposition of the second material may cause the first material to decompose faster than it normally would as this accelerated decomposition may be based on the first material being in close proximity to microbes decomposing the second material.

The microbial life that consumes PLA and similar materials in the process of biodegradation are restricted by the surface area of material they are acting on. As the surface area to volume ratio of any substance decreases, the breakdown of that substance also decreases, though not necessarily in a linear proportion. Moreover, PLA is hydrophobic due to the single bond CH3 side groups. The lactide methyl group provides a shielding effect (of the susceptible ester group) and renders polylactide more hydrophobic than, for example, polyglycolide; therefore, polylactide degrades slower than polyglycolide and other materials with less hydrophobicity. The second compostable material may be, for example, cellulose fiber or a material comprised thereof. Cellulose is a simple polymer, but it forms insoluble, crystalline microfibrils, which are highly resistant to enzymatic hydrolysis. All organisms known to degrade cellulose efficiently produce a battery of enzymes with different specificities, which act together in synergism. Cellulose fibers are hydrophilic due to the presence of —OH groups at their surfaces. Cellulose also may be prepared in such a way to provide a material of high porosity, since material made from cellulose contains a plurality of fibers, the material has a higher surface area than similarly sized thermoplastics. Cellulose, therefore, makes an ideal second compostable material for the purposes of the present invention, providing the material properties which allow faster biodegradation compared to the first compostable material. In some embodiments, the second compostable material may also be, for example, a polymer selected from the group of polyhydroxyalkanoates (PHAs). One of the most common polymers belong to this class is polyhydroxybutyrate (PHB). PHB may be biodegraded by several forms of microbial life. For example, firmicutes and proteobacteria, Bacillus, Pseudomonas and Streptomyces species, Pseudomonas lemoigne, Comamonas sp. Acidovorax faecalis, Aspergillus fumigatus and Variovorax paradoxus are all soil microbes capable of degradation. As such, a first and second compostable material with differing rates of biodegradation may be received at step 210 of FIG. 2.

The process of making a cartridge may include placing a first compostable material and a second compostable material together, here the first compostable material and the second compostable material may have at least a portion of each material in surface contact with the other material. In one example, a PLA interior capsule or case of a beverage pod is placed inside of a cellulose outer shell by mechanical means. In another example, a cellulose shell may be coated or dipped in liquid PLA and the liquid PLA may be allowed to solidify around at least a portion of the cellulose shell, providing increased contact between the cellulose and the PLA materials.

The lid 105 with the case 120 of FIG. 1 may be aligned and this lid and case may be bound together by mechanical, energetic, and/or chemical means, this process may attach a lid made of PLA to a case made of cellulose. In certain instances, a first and second material may be ground up and combined to form a lid and case that are subsequently attached by ultrasonic welding, by adhesive, or by other means. As mentioned above, completing the assembly of a container may include coating of the container with a selected material using a spray or a mold. When two different materials are attached to each other, these two materials may have interlocking features, such as mechanical teeth, which affix the two materials together when sufficient mechanical contact has been made. As mentioned above, completing the assembly of a container may include coating of the container with a selected material using a spray or a mold.

Processes for forming pieces of the container into a desired shape may be performed using vacuum thermoforming, injection molding, mechanical stamping, or some combination thereof. It should be understood the materials may be formed at any stage in the process, e.g., before the materials are affixed, such that the two materials are formed in such a way to be easily placed together and affixed. In other instances, the joined materials may be formed after they are affixed, such as, for example, creating a sheet that comprises the two materials (e.g. PLA and cellulose, or PLA and PHB, etc.).

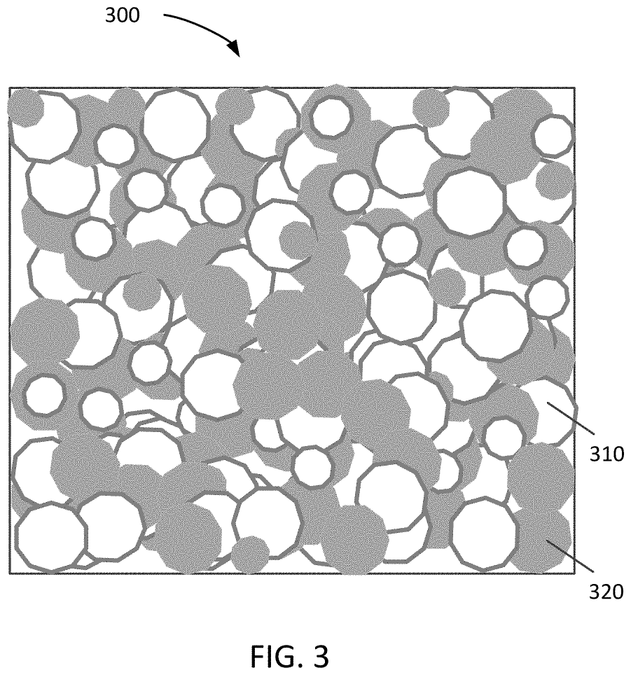

FIG. 3 displays a graphical representation of a blend or composite of materials used to make portion of a beverage container. For example, FIG. 3 may illustrate PLA combined with PHB or other material. This blend or composite 300 includes a first compostable/biodegradable material 310 and a second compostable/biodegradable material 320. Here again, the first compostable material may have reduced rate of decomposition compared to the second compostable material. By using different materials, such a material blend composite helps increase the speed of decomposition of the first compostable material based on an average porosity of the blend of the two different materials. Furthermore, the two materials may or may not be blended in equal proportions. For example, the blend may include a majority of the first compostable material (e.g. more than 50% by weight and/or volume) compared to the second compostable material. Relative proportions of the first and the second compostable material may be relative percentages of mass or volume. For example, a mass of the first compostable material to the second compostable material could be proportions of 40 percent (%) to 60% and these proportions could be expressed as a ratio of masses 40/60. Such a mass ratio could be used either when the two different materials have similar volumetric densities or when the two different materials have different volumetric densities. In certain instances, these proportions could be expressed as a ratio of volumes.

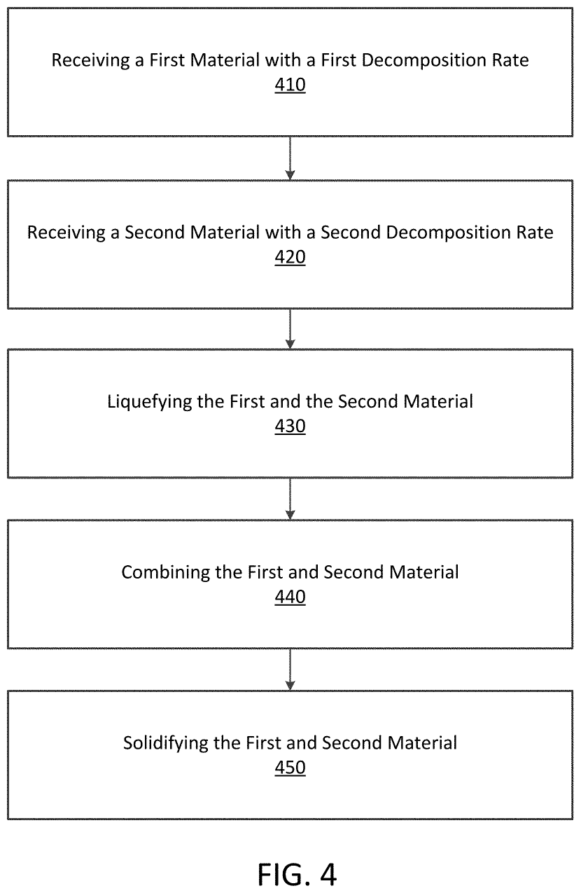

FIG. 4 illustrates a method for combining two different materials with different decomposition rates into a blend or composite material. FIG. 2 begins with step 410 where a first material with a first decomposition rate is received. Next in step 420 a second material with a second decomposition rate is received. Steps 410 and 420 may include respectively receiving a biodegradable thermoplastic polymer, such as polylactic acid (PLA) that includes lactic acid copolymers and receiving a second compostable material with faster rate of decomposition compared to the first compostable material. This second compostable may also be a biodegradable thermoplastic polymer, that may have been from a group of polyhydroxyalkanoates (PHAs) materials.

After step 420, the first and second materials may be liquefied in step 430. The liquefying of the first and second compostable material may include bringing both materials to or near their melting point. Since PLA has a melting temperature of approximately 150 to 160 degrees Celsius (C) (423 to 433 K) and since a PHB has a melting point of approximately 175 to 180 degrees C., a melting temperature of 180 C may be selected. In some embodiments, the first and second compostable materials may be selected for a close proximity of their melting points. The family of thermoplastic polymers known as PHBs from which the second compostable material may be selected have a wide range of melting points, from approximately 40 to 180 degrees C.

After the two different materials have been liquefied, they may be combined instep 440. This may include blending the liquefied first and second compostable material by pouring of the liquefied materials into a mechanical blender or mixer, where they may be mixed together. This process could also include mixing the materials in a nozzle when injecting these materials into a mold or form.

While some thermoplastic polymers mix well with each other (e.g., miscible, or compatible blends), many polymers tend to phase segregate. Phase segregation is a type of separation that may being spontaneously. This segregation process may result in formation of polymer chains with clear boundaries. In some embodiments, the addition of a relatively small amount of special polymers (referred to as compatibilizers) may encourage the two thermoplastic polymers to achieve a blend without phase segregation. In certain instances, however, these compatibilizers may not be ideal for use in a compostable material due to the potential for environmental contamination from the composting process of the final material. It may, therefore, be desirable to rapidly solidify the blended first and second compostable materials by cooling the mixture of materials. This may include rapidly chilling the mixture by placing the mixture into a freezer or other chilled environment. Rapid chilling may also be performed by exposing the mixture or the aforementioned mold to a chilled liquid or gas.

Rapidly solidifying the blended first and second compostable material by introducing an extremely low temperature (via thermal conduction, convection, etc.) may rapidly induce crystallization or glass transition in both the first and second compostable materials to obtain a blended compostable thermoplastic similar to the blend illustrated in FIG. 3.

The blend of materials may then be solidified by using the aforementioned compatibilizers, by cooling the mixture, or by other means in step 450 of FIG. 4. This blend of materials may be formed in shapes or in sheets that are subsequently processed. This subsequent processing may include cutting, stamping, forming, and/or bonding of material blend.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method for making a container, the method comprising:
receiving a first material and a second material for making the container, the first material associated with a first decomposition rate and the second material associated with a second decomposition rate that is different from the first decomposition rate;
fabricating a first portion of the container from at least one of the first or the second material;
fabricating a second portion of the container, wherein the second portion of the container includes one or more of the first material or the second material;
inserting a filter into the second portion of the container, wherein the filter contains a material for making a beverage; and
bonding the first portion of the container to the second portion of the container, wherein the container biodegrades based on the container including both the first and the second material after the beverage has been made from the beverage making material.

2. The method of claim 1, further comprising providing a liquefied portion of the first material into a mold when at least one of the first portion or the second portion of the container are fabricated.

3. The method of claim 1, further comprising providing a liquefied portion of the second material into a mold when at least one of the first portion or the second portion of the container are fabricated.

4. The method of claim 1, further comprising combining the first material and the second material, wherein the first portion of the container and the second portion of the container are fabricated from the combined first and second materials.

6. The method of claim 4, further comprising moving the combined liquefied materials into a mold.

7. The method of claim 4, further comprising identifying a ratio of the first material as compared to the second material to combine.

8. The method of claim 4, further comprising liquefying the first material and the second material.

9. The method of claim 4, further comprising moving the combined liquefied materials into a mold.

10. The method of claim 1, wherein the second portion of the container is fabricated by:
creating a sheet that includes the one or more of the first material or the second material; and
forming the sheet in a shape of the second portion of the container.

11. The method of claim 1, further comprising coating an exterior surface of the container with the first material.

12. The method of claim 1, wherein the first portion of the container is fabricated from the first material and the second portion of the container is fabricated from the second material.

13. The method of claim 1, wherein the first material includes polylactic acid (PLA) and the second material includes cellulose.

14. The method of claim 1, wherein the first material includes polylactic acid (PLA) and the second material includes polyhydroxybutyrate (PHB).

15. The method of claim 1, wherein the biodegrading of the container is faster than at least one of the first decomposition rate or the second decomposition rate.

16. A container for making a beverage, the container comprising:
a first portion of the container that includes at least one of a first material associated with a first decomposition rate and a second material associated with a second decomposition rate that is different from the first decomposition rate;
a second portion of the container, wherein the second portion of the container includes one or more of the first material or the second material; and
a filter included in the second portion of the container, wherein the filter contains a material for making a beverage and the container biodegrades after the beverage has been made from the beverage making material as a result of the container including both the first and the second material.

17. The container of claim 16, further comprising a coating that coats an exterior portion of the container.

18. The container of claim 16, wherein the coating includes the first material.

19. The container of claim 16, wherein the coating includes the second material.

20. The container of claim 16, further comprising a third biodegradable material incorporated into the container.
